(19) United States
(12) Patent Application Publication
(10) Pub. No.: US 2026/0156428 A1
(43) Pub. Date: Jun. 4, 2026

(54) METHOD OF CALCULATING AN AUDIO CALIBRATION PROFILE

(71) Applicant: Analog Devices International Unlimited Company, Limerick (IE)

(72) Inventors: Santosh Bharadwaj SINGH, Telangana (IN); Eoin ENGLISH, Pallasgreen (IE); Michael Thomas CORRIGAN, Limerick (IE); Aravind K. NAVADA, Bangalore (IN); Kaushal SANGHAI, Needham, MA (US); T.V.B. SUBRAHMANYAM, Gurgaon (IN)

(21) Appl. No.: 18/685,839

(22) PCT Filed: Aug. 19, 2022
(86) PCT No.: PCT/EP2022/073246

§ 371 Date: Feb. 22, 2024

(30) Foreign Application Priority Data
Aug. 23, 2021 (IN) 202141038169

(51) Int. Cl. H04S 7/00

(52) U.S. Cl. CPC H04S 7/301; H04S 2400/11; H04S 2400/15

(57) ABSTRACT

The present disclosure relates to a method of calculating an audio calibration profile for a three-dimensional space such as a room. The present disclosure achieves this by creating a model of the three-dimensional space using three-dimensional (3D) imaging techniques in conjunction with feedback from a sound recording device. The information gathered can be used by a digital signal processing (DSP) device to perform room equalisation. The information can also be used by beamforming audio sources to adjust beam characteristics to recreate the ideal spatial or surround sound experience at the user's location in the three-dimensional space.

### CROSS-REFERENCE TO RELATED APPLICATIONS

This application is a 35 U.S.C. § 371 National Stage Application of International Patent Application No. PCT/EP2022/073246, filed Aug. 19, 2022, which application claims the benefit of and priority to Indian Patent Application No. 202141038169, filed Aug. 23, 2021, the contents of each of which applications are hereby incorporated by reference herein in their entireties.

### TECHNICAL FIELD OF THE DISCLOSURE

The present disclosure relates to a method of calculating an audio calibration profile for a three-dimensional space. The present disclosure also relates to a system for calculating an audio calibration profile for a three-dimensional space, and a processing system for calculating an audio calibration profile for a three-dimensional space.

### BACKGROUND

Surround sound is a sound reproduction technique which provides audio from multiple speakers surrounding a user. Common surround sound standards include the 5.1 and 7.1 standards. Immersive surround sound technology is a particular surround sound technique that expands upon the 5.1 and 7.1 set-ups with audio channels coming from overhead. To achieve this effect, speakers would need to be placed in multiple places around a room as well as on the ceiling. In a domestic environment this is undesirable, so digital signal processing (DSP) methods can be used to create an immersive surround sound effect by bouncing sound off walls and ceilings to give the user the impression that sounds are coming from all around them.

### BRIEF SUMMARY OF THE DISCLOSURE

The present disclosure relates to a method of calculating an audio calibration profile for a three-dimensional space such as a room. The present disclosure achieves this by creating a model of the three-dimensional space using three-dimensional (3D) imaging techniques in conjunction with feedback from a sound recording device. The information gathered can be used by a DSP device to perform room equalisation. The information can also be used by beamforming audio sources to adjust beam characteristics to recreate the ideal spatial or surround sound experience at the user's location in the three-dimensional space.

In accordance with embodiments of the disclosure, there is provided a method of calculating an audio calibration profile for a three-dimensional space. The method comprises: outputting, by a first electronic apparatus, one or more test sounds; recording, by a second electronic apparatus, at each of one or more locations in a three-dimensional space, the one or more test sounds, wherein the second electronic apparatus is a mobile electronic apparatus; determining, by the first electronic apparatus or the second electronic apparatus, spatial coordinates corresponding to each of the one or more locations; generating a local audio profile for each of the locations based on the spatial coordinates determined for the location and the one or more test sounds recorded at the location; mapping, by the first electronic apparatus or the second electronic apparatus, the three-dimensional space; generating a model of the three-dimensional space based on the mapping; and calculating an audio calibration profile for the three-dimensional space based on the model of the three-dimensional space and the local audio profiles.

Mapping the three-dimensional space may comprise identifying one or more boundaries of the three-dimensional space.

Generating the model of the three-dimensional space may comprise generating models of the one or more boundaries.

Generating the model of the three-dimensional space may comprise assigning sound reflection properties to the models of the one or more boundaries.

At least one of the boundaries may comprise an opening, and the model of the at least one boundary may include a model of the opening.

Mapping the three-dimensional space may comprise identifying one or more objects located in the three-dimensional space.

Generating the model of the three-dimensional space may comprise generating models of the one or more objects.

Generating the model of the three-dimensional space may comprise assigning sound reflection properties to the models of the one or more objects.

The method may comprise generating a model of the second electronic apparatus. Calculating the audio calibration profile for the three-dimensional space may comprise compensating for the presence of the second electronic apparatus based on the model of the second electronic apparatus.

The method may comprise generating a model of a user. Calculating the audio calibration profile for the three-dimensional space may comprise compensating for the presence of the user based on the model of the user.

Calculating the audio calibration profile for the three-dimensional space may comprise calculating frequency equalization information.

The method may comprise outputting the calculated audio calibration profile to the first electronic apparatus, and outputting, by the first electronic apparatus, sound according to the audio calibration profile.

In accordance with embodiments of the disclosure, there is provided a system for calculating an audio calibration profile for a three-dimensional space. The system comprises: a first electronic apparatus comprising a sound output device configured to output one or more test sounds; and a second electronic apparatus comprising a sound recording device configured to record, at one or more locations in a three-dimensional space, the one or more test sounds, wherein the second electronic apparatus is a mobile electronic apparatus. At least one of the first electronic apparatus and the second electronic apparatus comprises a three-dimensional imaging device configured to record spatial coordinates corresponding to each of the one or more locations. At least one of the first electronic apparatus and the second electronic apparatus is configured to generate a local audio profile for each of the locations based on the spatial coordinates recorded for the location and the one or more test sounds recorded at the location. The three-dimensional imaging device is further configured to map the three-dimensional space and generate a model of the three-dimensional space based on the mapping. The system further comprises one or more processors configured to calculate an audio calibration profile for the three-dimensional space based on the model of the three-dimensional space and the local audio profiles.

The first electronic apparatus may be a soundbar device.

The second electronic apparatus may be a mobile phone or a microphone.

The three-dimensional imaging device may comprise a time of flight camera.

At least one of the one or more processors may be a cloud-based processor.

The first electronic apparatus may comprise at least one of the one or more processors.

The second electronic apparatus may comprise at least one of the one or more processors.

The one or more processors may comprise one or more digital signal processors.

The three-dimensional imaging device may be configured to identify one or more boundaries of the three-dimensional space and/or one or more objects located in the three-dimensional space.

The one or more processors may be configured to output the calculated audio calibration profile to the first electronic apparatus, and the first electronic apparatus may be configured to output sound according to the audio calibration profile.

In accordance with embodiments of the disclosure, there is provided a processing system for calculating an audio calibration profile for a three-dimensional space. The processing system comprises one or more processors configured to: receive a model of a three-dimensional space; receive one or more local audio profiles corresponding to respective locations in the three-dimensional space, the one or more local audio profiles being based on spatial coordinates recorded for the locations and one or more test sounds recorded at the locations; and calculate an audio calibration profile for the three-dimensional space based on the model of the three-dimensional space and the local audio profiles.

The one or more processors may be further configured to: process one or more audio signals according to the audio calibration profile.

The one or more processors may comprise one or more digital signal processors.

In accordance with embodiments of the disclosure, there is provided a system for calculating an audio calibration profile for a three-dimensional space. The system comprises: means for outputting one or more test sounds; means for recording, at each of one or more locations in a three-dimensional space, the one or more test sounds; means for determining spatial coordinates corresponding to each of the one or more locations; means for generating a local audio profile for each of the locations based on the spatial coordinates determined for the location and the one or more test sounds recorded at the location; means for mapping the three-dimensional space; means for generating a model of the three-dimensional space based on the mapping; and means for calculating an audio calibration profile for the three-dimensional space based on the model of the three-dimensional space and the local audio profiles.

Further features, examples, and advantages of the present disclosure will be apparent from the following description and from the appended claims.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, and in which:

FIG. 1 is a block diagram of a system according to embodiments of the disclosure;

FIG. 2 is a block diagram of a system according to embodiments of the disclosure;

FIG. 3 is a block diagram of a system according to embodiments of the disclosure;

FIG. 4 is a schematic diagram of the system shown in FIG. 1; and

FIG. 5 is a flow diagram of a method according to embodiments of the disclosure.

### DETAILED DESCRIPTION

The present disclosure relates to a system including a first electronic apparatus, such as a soundbar device, and a second electronic apparatus, such as a mobile phone.

The first electronic apparatus may include one speaker or multiple speakers (e.g. five or seven speakers). In examples where the first electronic apparatus includes multiple speakers, each speaker may correspond to a different channel of the first electronic apparatus. For example, the first electronic apparatus may have five channels or seven channels. The first electronic apparatus may include an enclosure housing the speakers.

The sound output device of the first electronic apparatus can output a series of test sounds which are recorded by the second electronic apparatus at multiple locations in a three-dimensional space such as a room. These recordings provide information about the sound reproduction characteristics of the three-dimensional space at each of the locations.

One or both of the first and second electronic apparatuses includes a 3D imaging device which can map the three-dimensional space and generate a model of the three-dimensional space based on the mapping. In addition, the 3D imaging device records spatial coordinates corresponding to each of the locations, as the test sounds are being recorded. Herein, electronic apparatuses which include a 3D imaging device are labelled “A”, while electronic apparatuses without a 3D imaging device are labelled “B”.

The system also includes a processing system such as a cloud processing system. The recordings of the test sounds and their associated spatial coordinates are transmitted to the processing system, together with the model of the three-dimensional space. The processing system can use all of this information to generate an audio calibration profile for the three-dimensional space via a simulation such as a multi-physics simulation. For example, the audio calibration profile may include frequency equalization information for various locations in the three-dimensional space. Alternatively or in addition, the audio calibration profile may include transient playback delays for different speakers, e.g. speakers of the first electronic apparatus.

The processing system transmits the audio calibration profile to a sound output device located in the three-dimensional space (e.g. the first electronic apparatus). The sound output device can use the audio calibration profile to optimise the sound it outputs for any given location in the three-dimensional space. For example, the sound output device may use the audio calibration profile to flatten the frequency response for a given location in the three-dimensional space.

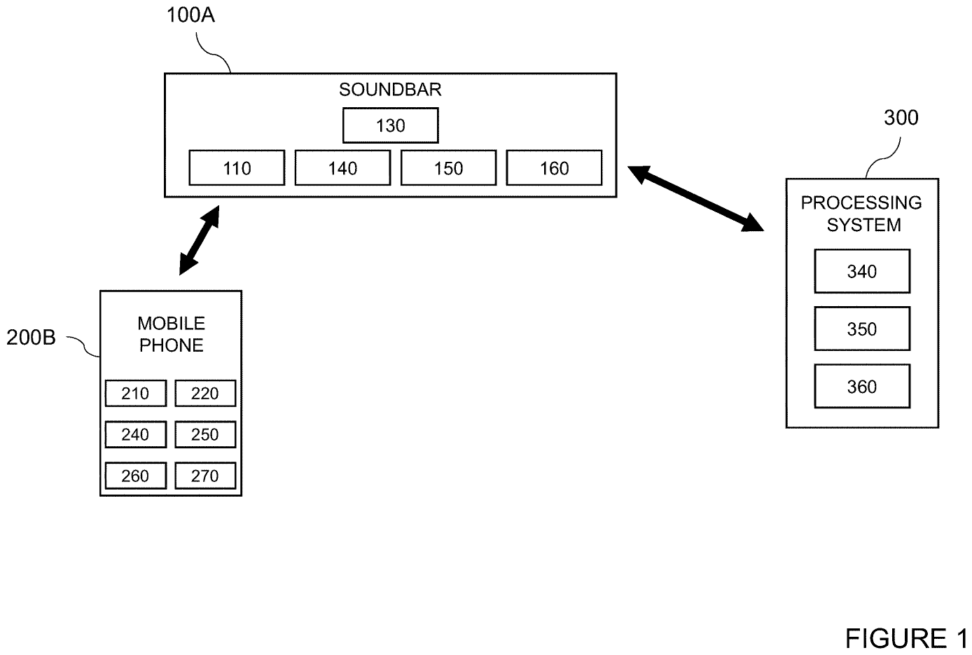

FIG. 1 is a block diagram showing a system according to embodiments of the disclosure.

The system includes a first electronic apparatus 100A, a second electronic apparatus 200B and a processing system 300.

The first electronic apparatus 100A is an electronic apparatus which is designed to be installed at a particular location in a three-dimensional space, such as a room. In the present example, the first electronic apparatus 100A is a soundbar device. The soundbar device 100A includes multiple speakers (in the present case, five speakers), which are housed within an enclosure (not shown).

The second electronic apparatus 200B is a mobile (or portable) electronic apparatus. In the present example, the second electronic apparatus is a mobile phone. In other examples, the second electronic device may be a microphone.

The first electronic apparatus 100A includes a sound output device 110 which is configured to output sound, e.g. a test sound or a series of test sounds. The sound output device 110 includes the speakers. In normal use, the sound output device 110 may output sound based on an audio signal which is received from another device, such as a television (not shown).

In the present example, the first electronic apparatus 100A includes a 3D imaging device 130 which is configured to map a three-dimensional space surrounding the first electronic apparatus 100 and generate a model of the three-dimensional space based on the mapping. Mapping the three-dimensional space may involve identifying one or more boundaries of the three-dimensional space, such as a ceiling of a room. In such cases, the 3D imaging device 130 may determine a maximum height for the ceiling. The 3D imaging device 130 may utilise any technology that can image a three-dimensional space and construct a 3D model, e.g. time-of-flight (ToF), radar and/or stereo vision. For example, the 3D imaging device 130 may include a time of flight camera, which may be an indirect time of flight or direct time of flight camera.

The 3D imaging device 130 is configured to detect the second electronic apparatus 200B at different locations in the three-dimensional space, and to record spatial coordinates corresponding to each location. The 3D imaging device 130 is also configured to record a time-stamp corresponding to each set of spatial coordinates.

In the present example, the 3D imaging device 130 detects the second electronic apparatus 200B using an object recognition process, i.e. the 3D imaging device 130 is trained to identify mobile phones. In examples where the second electronic apparatus 200B is a microphone, the 3D imaging device 130 is trained to identify microphones. In other examples, the second electronic apparatus 200B may include an identifier (e.g. a tag), and the 3D imaging device 130 is trained to identify the identifier of the second electronic apparatus 200B in order to detect the second electronic apparatus. In still other examples, the second electronic apparatus 200B may include a light source (e.g. a light emitting diode (LED)) which is configured to emit flashes of light at a certain frequency. In such examples, the 3D imaging device 130 is configured to identify the flashes of light in order to detect the second electronic apparatus 200B at a particular location in the three-dimensional space.

In some examples, the 3D imaging device 130 is configured to map the second electronic apparatus 200B and generate a model of the second electronic apparatus 200B. In some examples, the 3D imaging device is configured to map a user and generate a model of the user.

In some examples, the model of the three-dimensional space includes information about boundaries of the three-dimensional space, such as their locations and their sound reflection properties. The 3D imaging device 130 may also identify any openings in the boundaries of the three-dimensional space, and the locations of these openings can be recorded in the model. The 3D imaging device 130 may also identify objects in the three-dimensional space, and detect materials of the objects. The models of the objects may include information about their sound reflection properties. Any or all of this additional information may be incorporated into the model of the three-dimensional space, which allows for the model to more accurately represent the audio characteristics of the three-dimensional space.

The first electronic apparatus 100A also includes a processor 140, which is configured to control overall operations of the first electronic apparatus 100A, as well as a communicator 150 and a memory 160. The communicator 150 is configured to communicate with other devices in close proximity to the first electronic apparatus 100A (e.g. via Bluetooth or WiFi). The communicator 150 is also configured to communicate with the processing system 300 (e.g. via an internet connection).

The processor 140 can receive information from the second electronic apparatus 200B via the communicator 150, such as the recorded test sounds and a time-stamp for each set of recorded test sounds. Using time-stamps for the spatial coordinates and the recorded test sounds, the processor 140 can associate each set of recorded test sounds with a set of spatial coordinates. The test sounds recorded at a given location and the spatial coordinates determined for the location are referred to as a local audio profile for the location. The processor 140 can generate multiple local audio profiles and store these in the memory 160.

The processor 140 can transmit the local audio profiles for the locations to the processing system 300 via the communicator 150. The processor 140 can also transmit the model of the three-dimensional space to the processing system 300 via the communicator 150.

The second electronic apparatus 200B includes a sound recording device 220 which is configured to record sound, such as the test sounds output by the first electronic apparatus 100A. In the present example, the second electronic apparatus 200B also includes a sound output device 210 which is configured to output sound.

In the present example, the second electronic apparatus 200B includes a processor 240, which is configured to control overall operations of the second electronic apparatus 200B, as well as a communicator 250 and a memory 260. The processor 240 is configured to record a time-stamp associated with each recording of the test sounds.

The communicator 250 is configured to communicate with other devices, such as the first electronic device 100A, that are in close proximity to the second electronic apparatus 200B (e.g. via Bluetooth or WiFi). The communicator 250 may also be configured to communicate with the processing system 300 (e.g. via an internet connection). The second electronic apparatus 200B also includes a display 270, which may be a touchscreen.

In examples where the second electronic apparatus 200B is a microphone, the second electronic apparatus 200B includes a sound recording device 220, but other features such as the display may be omitted. The microphone may be connected to the first electronic apparatus 100A via a wired or wireless connection, so that the test sounds recorded by the microphone can be transmitted to the first electronic apparatus 100A. In examples where the second electronic apparatus 200B is a microphone, the processor 140 of the first electronic apparatus 100A may be configured to record a time-stamp for each set of recorded test sounds.

The processing system 300 includes one or more processors 340, a memory 350 and a communicator 360. The processors 340 are configured to receive information from the first electronic apparatus 100A and/or the second electronic apparatus 200B via the communicator 360. The processors 340 may include one or more digital signal processors (DSPs). In some examples, the processing system 300 is a cloud processing system (e.g. a cloud server) which is remote from the first electronic apparatus 100A and the second electronic apparatus 200B.

In the present example, the processors 340 are configured to receive the model of the three-dimensional space from the first electronic apparatus 100A. The processors 340 are also configured to receive the local audio profiles for the locations in the three-dimensional space from the first electronic apparatus 100A. In some examples, the processors 340 are configured to receive a model of the second electronic apparatus 200B, and/or a model of a user.

The processors 340 perform a multi-physics simulation based on the received information, and calculate an audio calibration profile for the three-dimensional space. The audio calibration profile may determine alterations that need to be made to an audio signal during playback, taking into account the geometry and the acoustic response of the three-dimensional space.

In examples where the processors 340 receive a model of the second electronic apparatus 200B, and/or a model of the user, the processors 340 can compensate for the presence of the second electronic apparatus 200B and/or the user in the three-dimensional space when calculating the audio calibration profile. In other words, the effects of the second electronic apparatus 200B and/or the user on the audio characteristics of the three-dimensional space can be discarded.

The processors 340 then transmit the audio calibration profile to the first electronic apparatus 100A via the communicator 360, and the first electronic apparatus 100A can output sound via the sound output device 110 based on the audio calibration profile. For example, the first electronic apparatus 100A may adjust parameters such as beam angle, path length, gain and focal length for each channel of the first electronic apparatus 100A.

Furthermore, during normal operation of the first electronic apparatus 100A, the model of the three-dimensional space can be updated based on information from the 3D imaging device 130 to account for the position of a user (or users) in the three-dimensional space. The updated model is then used to calculate an audio calibration profile which is adapted to the user's (or users') locations. This may provide an optimised experience for the user (or users). The first electronic apparatus 100A may also use the location of the user (or users) to adjust the beam characteristics of the speakers to create an ideal spatial or surround sound experience at the location(s).

The 3D imaging device 130 may periodically determine the location of a user (or users) in the three-dimensional space to ensure that the first electronic apparatus 100A is using the most optimal calibration profile for the user(s). If the location (or locations) of the user(s) differ from the positions at which the second electronic apparatus 200B was placed to record the test sounds by more than a predetermined threshold value, the first electronic apparatus device 100A may provide an output (e.g. a sound) indicating that the calibration process needs to be repeated.

The 3D imaging device 130 can also determine if objects in the three-dimensional space have been rearranged, or if new objects have been added, by comparing the locations of detected objects in the three-dimensional space with the previously generated model of the three-dimensional space. If the 3D imaging device 130 determines that the configuration of the objects has changed by more than a predetermined threshold value, the first electronic apparatus device 100A may provide an output (e.g. a sound) indicating that the calibration process needs to be repeated.

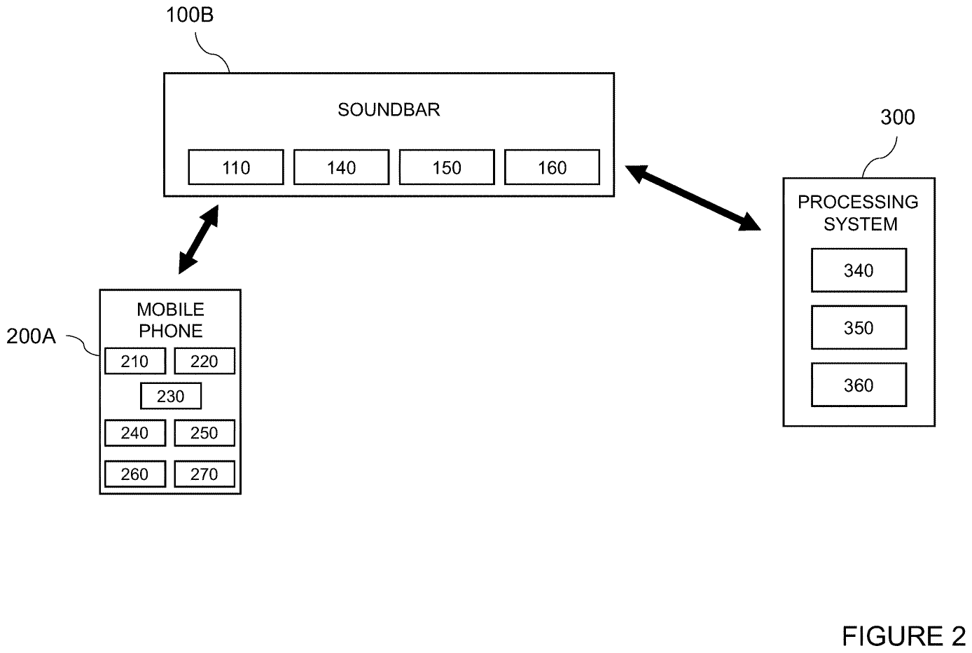

FIG. 2 is a block diagram showing a system according to embodiments of the disclosure.

The system includes a first electronic apparatus 100B, a second electronic apparatus 200A and a processing system 300. In the present example, the first electronic apparatus 100B is a soundbar device and the second electronic apparatus 200A is a mobile phone. By “soundbar device” we mean a device that has a plurality of independently drivable or addressable speakers or sounders mounted within the same physical speaker enclosure, such that the plurality of speakers or sounders are essentially co-located within the common enclosure which is then located at one point in the room. Such devices are well known in the art, and examples include the Sonos® Ray® and Beam® soundbars, available from Sonos Inc., Santa Barbara, CA. Such devices can be used independently on their own, or can be used together with other physically separate speakers provided in their own enclosures physically separated from the soundbar in the same room, for example to provide a full room surround sound system. In examples of the present disclosure the soundbar device is typically used on its own, without other physically separated speakers. The processing system 300 is the same as the processing system 300 described above in relation to FIG. 1, and so a detailed description of the processing system is omitted.

In contrast to the first electronic apparatus 100A shown in FIG. 1, the first electronic apparatus 100B does not include a 3D imaging device. Instead, the second electronic apparatus 200A includes a 3D imaging device 230, which is substantially the same as the 3D imaging device 130 described above in relation to FIG. 1. The 3D imaging device 230 may utilise any technology that can image a three-dimensional space and construct a 3D model, e.g. time-of-flight (ToF), radar and/or stereo vision. For example, the 3D imaging device 130 may include a time of flight camera, which may be an indirect time of flight or direct time of flight camera.

The 3D imaging device 230 is configured to map a three-dimensional space surrounding the second electronic apparatus 200A and generate a model of the three-dimensional space based on the mapping. The 3D imaging device 230 is also configured to determine spatial coordinates of objects in the three-dimensional space. For example, the 3D imaging device 230 can determine the location of the first electronic apparatus 100A within the three-dimensional space. The 3D imaging device 230 is configured to record spatial coordinates of the second electronic apparatus 200A at each location in the three-dimensional space where the test sounds are recorded. The processor 240 can generate local audio profile for each location, and can store the local audio profiles in the memory 260. The processor 240 can transmit the local audio profiles to the processing system 300 via the communicator 250. The processor 240 can also transmit the model of the three-dimensional space to the processing system 300 via the communicator 250.

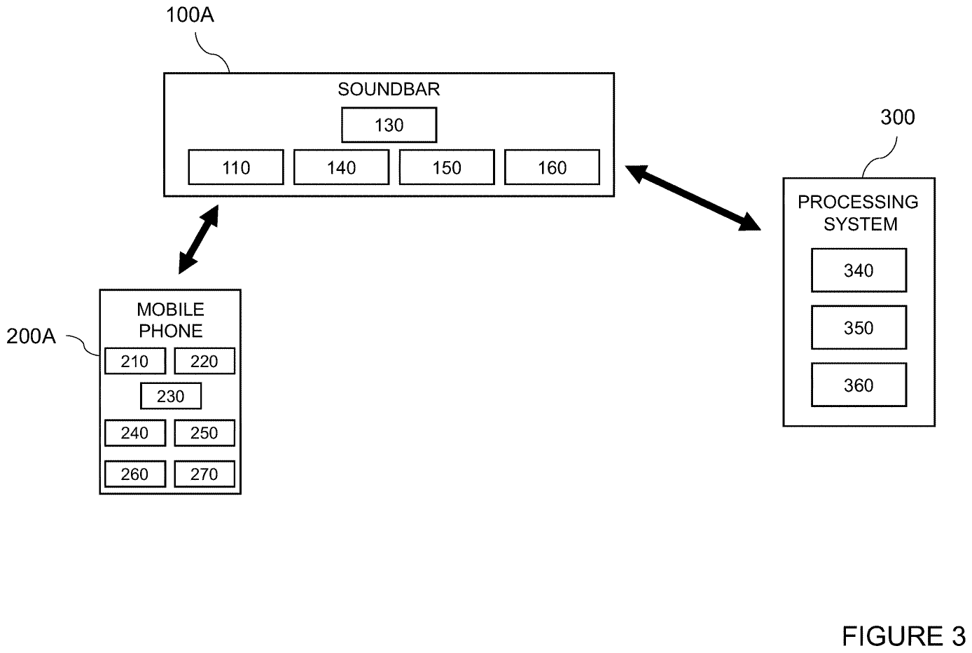

FIG. 3 is a block diagram showing a system according to embodiments of the disclosure.

The system includes a first electronic apparatus 100A, a second electronic apparatus 200A and a processing system 300. The first electronic apparatus 100A is a soundbar device and the second electronic apparatus 200A is a mobile phone. The processing system 300 is the same as the processing system 300 described above in relation to FIG. 1, and so a detailed description of the processing system is omitted.

In the system shown in FIG. 3, the first electronic apparatus 100A and the second electronic apparatus 200A each include a respective 3D imaging device 130, 230. In this example, the mapping of the three-dimensional space and the generating of the model of the three-dimensional space can be performed by either of the first electronic apparatus 100A and the second electronic apparatus 200A. Similarly, in this example, the recording of spatial coordinates corresponding to each location of the second electronic apparatus 200A can be performed by either of the first electronic apparatus 100A and the second electronic apparatus 200A.

The systems described above include a processing system in addition to the first electronic apparatus and the second electronic apparatus. In other examples, the system includes a first electronic apparatus and a second electronic apparatus without a separate processing system. In such examples, the processing performed by the processing system may be performed by the first electronic apparatus or the second electronic apparatus. In examples where the processing is performed by the first electronic apparatus or the second electronic apparatus, the processing may include processing one or more audio signals according to the audio calibration profile. These processed audio signals may be output by a sound output device of the first electronic apparatus or the second electronic apparatus.

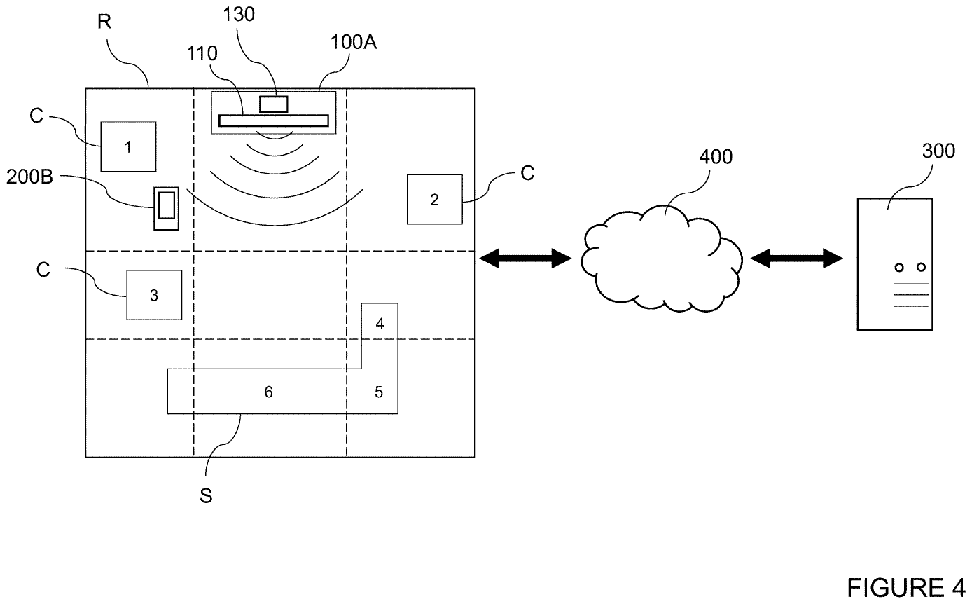

FIG. 4 is a schematic diagram of a system as shown in FIG. 1. The system includes a soundbar device 100A, a mobile phone 200B and a cloud processing system 300.

In the present example, the soundbar device 100A is installed at a particular location in a room R. The mobile phone 200B is also located within the room R, and can be moved to different locations in the room R by a user. The cloud processing system 300 is at a location remote from the room R, and is connected to the soundbar device 100A and/or the mobile phone 200B via an internet connection 400.

The room R is divided into six listening zones 1-6. Listening zones 1-3 correspond to the positions of chairs C within the room R, while listening zones 4-6 correspond to different positions on a sofa S. FIG. 4 shows the mobile phone 200B located in listening zone 1. This arrangement of listening zones is only exemplary, and in general the number of listening zones and their respective positions may be determined according to the size of the room and the potential number of users within the room.

During the calibration process, the mobile phone 200B is placed in each of the listening zones 1-6. When the mobile phone 200B is located in a given listening zone, the sound output device 110 of the soundbar device 100A plays a series of test sounds which are recorded by the mobile phone 200B. For each listening zone, the 3D imaging device 130 of the soundbar device 100A captures the X, Y, Z coordinates of the mobile phone 200B within the room R. The soundbar device 100A receives the recorded test sounds for each listening zone from the mobile phone 200B, and stores the recorded test sounds and the location of the mobile phone 200B for each listening zone as a local audio profile for the listening zone.

The 3D imaging device 130 of the soundbar device 100A maps the room within its field-of-view (FoV), and based on the data obtained from the mapping process, creates a model of the room R. This mapping process may take place either before or after the recording of the test sounds by the mobile phone 200B. The model of the room R includes information about the boundaries of the room R, such as the locations of the floor, the ceiling and the walls of the room R. The 3D imaging device 130 may also identify any openings in the boundaries, such as windows or ventilator shafts, and these may be included in the model.

The 3D imaging device 130 may also identify objects in the room R such as the chairs C and the sofa S. The 3D imaging device 130 may also be able to detect materials of objects in the room R. This additional information may be incorporated into the model of the room R. This allows for the model to more accurately represent the audio characteristics of the room R.

Once the recording of the test sounds and the generation of the model is complete, the soundbar device 100A sends the model of the room and the local audio profiles for the listening zones to the cloud processing system 300 via the internet connection 400. The cloud processing system 300 performs a multi-physics simulation of the room R using the model of the room R and the local audio profiles, and generates an audio calibration profile for the room R. The audio calibration profile for the room R is then transmitted to the soundbar device 100A via the internet connection 400.

During operation of the soundbar device 100A, the model of the room R can be updated based on information from the 3D imaging device 130 to account for the position of a user (or users) in the room R, in particular, which listening zone the user is located in. The soundbar device 100A can use an appropriate audio equalization profile for the user within a listening zone, based on the audio calibration profile for the room R received from the cloud processing system 300.

The 3D imaging device 130 can determine if furniture in the room R (e.g. the chairs C and the sofa S) has been re-arranged, or if new furniture has been added to the room R. If the 3D imaging device determines that the furniture has moved from the previously detected positions, outside a certain threshold, the soundbar device 100A may provide an output (e.g. a sound) indicating that the calibration process needs to be repeated.

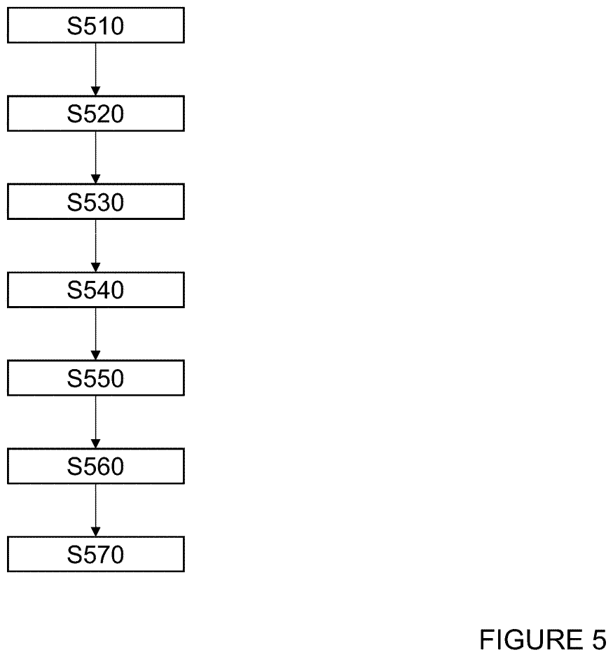

FIG. 5 is a flow diagram showing a method according to embodiments of the disclosure.

The method comprises outputting, by a first electronic apparatus, one or more test sounds (S510); and recording, by a second electronic apparatus, at each of one or more locations in a three-dimensional space, the one or more test sounds (S520). The second electronic apparatus is a mobile apparatus.

The method further comprises determining, by the first electronic apparatus or the second electronic apparatus, spatial coordinates corresponding to each of the one or more locations (S530).

The method further comprises generating a local audio profile for each of the locations based on the spatial coordinates determined for the location and the one or more test sounds recorded at the location (S540). This step may be performed by the first electronic apparatus or the second electronic apparatus. Alternatively, this step may be performed by a processing system.

The method further comprises mapping, by the first electronic apparatus or the second electronic apparatus, the three-dimensional space (S550); and generating a model of the three-dimensional space based on the mapping (S560). Generating the model may be performed by the first electronic apparatus or the second electronic apparatus. Alternatively, this step may be performed by a processing system.

The method further comprises calculating an audio calibration profile for the three-dimensional space based on the model of the three-dimensional space and the local audio profiles (S570). This step may be performed by a processing system. Alternatively, this step may be performed by the first electronic apparatus or the second electronic apparatus.

It should be appreciated that the order of the steps of the method is not limited to the particular order shown in FIG. 5. For example, steps 550 and 560 may be performed before steps 510-540.

Various further modifications to the above described examples, whether by way of addition, deletion or substitution, will be apparent to the skilled person to provide additional examples, any and all of which are intended to be encompassed by the appended claims.

What is claimed is:

1. A method of calculating an audio calibration profile for a three-dimensional space, the method comprising:
outputting, by a first electronic apparatus, one or more test sounds;
recording, by a second electronic apparatus, at each of one or more locations in a three-dimensional space, the one or more test sounds, wherein the second electronic apparatus is a mobile electronic apparatus;
determining, by the first electronic apparatus or the second electronic apparatus, spatial coordinates corresponding to each of the one or more locations;
generating a local audio profile for each of the locations based on the spatial coordinates determined for the location and the one or more test sounds recorded at the location;
mapping, by the first electronic apparatus or the second electronic apparatus, the three-dimensional space;
generating a model of the three-dimensional space based on the mapping; and
calculating an audio calibration profile for the three-dimensional space based on the model of the three-dimensional space and the local audio profiles.

2. The method according to claim 1, wherein mapping the three-dimensional space comprises identifying one or more boundaries of the three-dimensional space.

3. The method according to claim 2, wherein generating the model of the three-dimensional space comprises generating models of the one or more boundaries.

4. The method according to claim 3, wherein generating the model of the three-dimensional space comprises assigning sound reflection properties to the models of the one or more boundaries.

5. The method according to claim 3, wherein at least one of the boundaries comprises an opening, and wherein the model of the at least one boundary includes a model of the opening.

6. The method according to claim 1, wherein mapping the three-dimensional space comprises identifying one or more objects located in the three-dimensional space.

7. The method according to claim 6, wherein generating the model of the three-dimensional space comprises generating models of the one or more objects, and optionally wherein generating the model of the three-dimensional space comprises assigning sound reflection properties to the models of the one or more objects.

8. The method according to claim 1, comprising generating a model of the second electronic apparatus, wherein calculating the audio calibration profile for the three-dimensional space comprises compensating for the presence of the second electronic apparatus based on the model of the second electronic apparatus.

9. The method according to claim 1, comprising generating a model of a user, wherein calculating the audio calibration profile for the three-dimensional space comprises compensating for the presence of the user based on the model of the user.

10. The method according to claim 1, wherein calculating the audio calibration profile for the three-dimensional space comprises calculating frequency equalization information.

11. The method according to claim 1, further comprising outputting the calculated audio calibration profile to the first electronic apparatus, and outputting, by the first electronic apparatus, sound according to the audio calibration profile.

12. A system for calculating an audio calibration profile for a three-dimensional space, the system comprising:
a first electronic apparatus comprising a sound output device configured to output one or more test sounds; and
a second electronic apparatus comprising a sound recording device configured to record, at one or more locations in a three-dimensional space, the one or more test sounds, wherein the second electronic apparatus is a mobile electronic apparatus;
wherein at least one of the first electronic apparatus and the second electronic apparatus comprises a three-dimensional imaging device configured to record spatial coordinates corresponding to each of the one or more locations,
wherein at least one of the first electronic apparatus and the second electronic apparatus is configured to generate a local audio profile for each of the locations based on the spatial coordinates recorded for the location and the one or more test sounds recorded at the location, and
wherein the three-dimensional imaging device is further configured to map the three-dimensional space and generate a model of the three-dimensional space based on the mapping; and
wherein the system further comprises one or more processors configured to calculate an audio calibration profile for the three-dimensional space based on the model of the three-dimensional space and the local audio profiles.

13. The system according to claim 12, wherein the first electronic apparatus is a soundbar device.

14. The system according to claim 12, wherein the second electronic apparatus is a mobile phone or a microphone.

15. The system according to claim 12, wherein the three-dimensional imaging device comprises a time of flight camera.

16. The system according to claim 12, wherein at least one of the following applies:
at least one of the one or more processors is a cloud-based processor;
the first electronic apparatus comprises at least one of the one or more processors; and
the second electronic apparatus comprises at least one of the one or more processors.

17. The system according to claim 12, wherein the three-dimensional imaging device is configured to identify one or more boundaries of the three-dimensional space and/or one or more objects located in the three-dimensional space.

18. The system according to claim 12, wherein the one or more processors are configured to output the calculated audio calibration profile to the first electronic apparatus, and
the first electronic apparatus is configured to output sound according to the audio calibration profile.

19. A processing system for calculating an audio calibration profile for a three-dimensional space, the processing system comprising one or more processors configured to:
receive a model of a three-dimensional space;
receive one or more local audio profiles corresponding to respective locations in the three-dimensional space and being based on spatial coordinates recorded for the locations and one or more test sounds recorded at the locations; and
calculate an audio calibration profile for the three-dimensional space based on the model of the three-dimensional space and the local audio profiles.

20. The processing system according to claim 19, wherein the one or more processors are further configured to:
process one or more audio signals according to the audio calibration profile.
